(19) United States
(12) Patent Application Publication
(10) Pub. No.: US 2002/0154662 A1
(43) Pub. Date: Oct. 24, 2002

(54) Method and apparatus for precision wavelength stabilization in fiber optic communication systems using an optical tapped delay line

(76) Inventors: Terry M. Turpin, Columbia, MD (US); D. Bruce Nichols, Columbia, MD (US)

Correspondence Address: Alex Chartove, Morrison & Foerster LLP, 2000 Pennsylvania Ave., N.W., Washington, DC, 20006-1888, US

(21) Appl. No.: 10/100,203

(22) Filed: Mar. 19, 2002

Related U.S. Application Data
(60) Provisional application No. 60/276,484, filed on Mar. 19, 2001.

(51) Int. Cl. H01S 3/10

(52) U.S. Cl. 372/20

(57) ABSTRACT

A method and apparatus for precision stabilization in optical communication systems, characterized by an optical tapped delay line which resolves multiple wavelength signals having extremely narrow wavelength spacing. The invention has particular utility in future DWDM systems having channel spacing at or below 25 GHz. Laser output wavelengths are alternatively or simultaneously locked, tuned or monitored depending upon the embodiments selected.

### FIELD OF THE INVENTION

This invention pertains to the field of optical devices, and more particularly to precise wavelength control of laser sources for wavelength division multiplexing (WDM) communications systems.

### BACKGROUND OF THE INVENTION

Wavelength division multiplexing (WDM) systems communicate multiple signals through a single optical fiber by utilizing a different optical wavelength for each carrier signal. In the multiplexing process, an information signal is combined with a carrier signal and multiple such combined signals, called channels, are multiplexed into a single optical fiber for simultaneous transmission. Demultiplexing involves the separation of channels into individual data-carrying signals. The International Telecommunications Union has developed standards for WDM with predefined frequencies at channel spacings of 100 GHz (or 0.8 nm). By reducing the channel spacing, increased numbers of data-carrying channels may be added. Because of ever-increasing bandwidth requirements, telecommunications carriers need more channels of information and narrow channel spacings of 25 GHz and below are being intensely studied.

For a number of reasons, practical systems utilizing 25 GHz and narrower spacing are developing slowly. In particular, maintaining increasingly narrower channel spacing demands extreme precision in the frequency stability from the source laser—a precision that is not reliably achievable. The wavelength of most lasers has a tendency to drift, and if the channel spacing is sufficiently close, crosstalk is introduced as the wavelength of one channel drifts closer to an adjacent channel. Factors such as equipment aging, device tolerances, power source fluctuations, and temperature changes all serve to complicate the problem.

It is well known that the frequency stability of WDM systems is highly temperature dependent. Temperature changes cause variations in the optical devices that have a direct impact on optical properties, for example, by expanding or contracting a material to alter its physical dimensions or by changing the index of refraction of a material. The likely result is that the frequency of interest “drifts” relative to the target or detector with a corresponding degradation of the signal. Active compensation systems employ heater/coolers to maintain the components at a constant temperature. These devices effectively solve the problem of frequency drift, but at relatively high cost and with a loss of overall efficiency due to the power requirements.

As a result of this problem, prior art solutions have been found that attempt to eliminate or minimize temperature-induced frequency drift. The various alternative devices to which this type of solution is applied are commonly referred to as wavelength references, wavelength lockers, or wavelength monitors. These devices vary in size, complexity and cost. Among the best performing wavelength lockers, from the standpoint of size, accuracy and cost, are those utilizing etalons.

A well-known etalon-based optical device for performing wavelength locking is a Fabry-Perot etalon, an example of which is illustrated in FIG. 1. It includes two parallel partially reflective mirrors 20 and 21. The mirrors are separated by a cavity 22, which might be an air space or alternatively, a solid transparent material. Light from a spectrally broadband source, i.e., a laser, is input at plane 25. In particular, a multi-spectral light ray input from point P₁ entering through the partially reflective mirror 20 at an angle θ undergoes multiple reflections between mirrors 20 and 21. The emerging light rays 26, having a common wavelength λ, interfere constructively along a circular locus P₂ in the output plane 27 where an appropriate detector might be positioned. The condition for constructive interference that relates a particular angle θ and a particular wavelength λ is given by the formula

2d cosθ=mλ

where d is the separation of the reflecting surfaces and m is an integer known as the order parameter. The Fabry-Perot etalon thereby separates the component frequencies of the input light by using multiple beam reflections and interferences.

When used in a wavelength locker, a portion of the modulated laser output beam is commonly split. One segment of the beam is routed directly to an output while a second segment first passes through the etalon before reaching a detector. Only the single wavelength λ exits the etalon and the device is designed to ensure that λ is the “lock” wavelength. Tuning is commonly achieved by physically rotating the etalon slightly during device fabrication. This position, and hence the lock wavelength of the device, is permanent once construction of the device is completed. Once the device is initially designed and calibrated, it defines a precise fixed relationship between the two signals provided to the detector. Variation of the relationship resulting from laser wavelength changes is monitored and the laser driver input is altered via a feedback loop to minimize detected differences. A more complete description of such a system may be found in the technical article entitled “Wavelength Lockers Make Fixed and Tunable Lasers Precise,” WDM Solutions, January 2002, p. 23.

The Fabry Perot etalon does not serve well as a WDM channelizer due to the difficulty in obtaining high optical throughput efficiency. If the input beam is divergent, e.g., the direct output of an optical fiber, then the output pattern for a given wavelength is a set of rings. Multiple wavelengths produce nested sets of concentric rings. It is difficult to collect this light efficiently and concentrate it at multiple detector points, or couple it to multiple output fibers, especially while maintaining the separation of wavelength components that the etalon has produced. If the input beam is collimated, e.g., the collimated output of an optical fiber, then the beam can be fanned over a narrow range of angles to produce only a single-order output (e.g., m=+1) for each wavelength of interest. This fanning makes it easy to concentrate the output light at multiple detector points or fibers, but there is inherently high loss.

U.S. Pat. Nos. 5,428,700, 5,798,859 and 5,825,792 to Hall, Colbourne et al, and Villeneuve et al. respectively all reveal laser stabilization systems employing Fabry-Perot etalons of the type described above.

U.S. Pat. No. 6,345,059 to Flanders describes a highly complex laser wavelength compensation system in which the tuned wavelength is maintained by controlling the optical length of the laser cavity. This disclosure states that the wavelength precision of this system is 0.1 nm accuracy, which equals 12.5 GHz channel spacing.

U.S. Pat. No. 6,289,028 B1 to Munks, et al. discloses the simultaneous monitoring, stabilizing, tuning, and control of laser source wavelengths with the aid of an error feedback loop. A rotatable optical filter provides wavelength tuning by tilting the filter in accordance with feedback signals.

An alternative type of wavelength locking is taught in PCT application IPO Number WO 01/35505 A1 to Sappey. A one or two-dimensional array of lasers at different spatial positions within an external resonating cavity illuminates a diffraction grating. Opposing the diffraction grating is either a mirror (in the one-dimensional case) or a second grating (in the two-dimensional case). Light fed back to the lasers causes the laser to lock to the wavelength of the feedback, resulting in each laser lasing as a discrete, well-controlled wavelength. Each channel of a WDM system requires its own stabilized laser.

Significant channel spacing reductions in WDM systems will require substantial improvements in wavelength stability, with the corresponding precision ability to monitor, tune and lock those wavelengths as needed.

### SUMMARY OF THE INVENTION

The present invention, in a preferred embodiment, utilizes unique properties of an optical time delay line (OTDL) to, with high precision, monitor, tune and lock optical wavelengths. It permits passive mechanical compensation of output variations in the wavelength of a laser, due to thermal effects, equipment aging, power fluctuations or other causes. The unique OTDL construction permits a collimated multi-spectral beam to be separated into its constituent wavelengths and detected with high precision. Wavelength drift may be measured by comparison circuitry at the output and feedback signals are generated to retune the laser to correct for the unwanted drift. Advantages of the present invention, in a preferred embodiment, include the ability to tune the lock frequency at much better precision than currently known and the freedom from the necessity to introduce a radio frequency modulation to determine the error signal direction.

It is an object of the invention, in a preferred embodiment, to permit measurement of laser lines of 1 pm (picometer) or narrower.

It is also an object of the invention, in a preferred embodiment, to stabilize multiple laser sources with a single OTDL device having little sensitivity to temperature change.

A wavelength stabilizer in accordance with a preferred embodiment of the invention would include a laser; an optical tapped delay line having an input for receiving a collimated beam of light from the laser and an output to which is provided multiple time-delayed output beams, the collimated beam comprising a plurality of predetermined wavelengths, the multiple time-delayed output beams being mutually phase-shifted as a function of the wavelengths of the collimated beam and being spatially distributed, whereby the collimated beam is channelized into constituent predetermined wavelengths; and, means connected to the output for detecting variations in the constituent wavelengths over time, and means for controlling the laser in accordance with the detected variations to return the collimated beams to their predetermined wavelengths.

### BRIEF DESCRIPTION OF THE DRAWINGS

The present invention, in a preferred embodiment, may be best understood when the detailed description below is read with reference to the attached drawings, in which:

FIG. 1 illustrates an example of a prior art etalon commonly used in laser locker applications.

FIG. 2 illustrates an example of a preferred optical tapped delay line suitable for use in accordance with the invention.

FIG. 3 illustrates an example of an operational side view of an optical tapped delay line suitable for use in accordance with the invention.

FIG. 4 illustrates an example of a laser wavelength locker in accordance with the teaching of the invention.

FIG. 5 illustrates an example of a spectrum analyzer in accordance with the teaching of the invention configured as a spectrum analyzer.

FIG. 6 illustrates an example of an embodiment of the invention configured as a Fabry-Perot resonator cavity.

FIG. 7 illustrates an example of an embodiment of the invention utilizing a ring resonator cavity.

FIG. 8 is a graph illustrating an example of the operation of measuring the drift of a laser line in a WDM system.

FIG. 9 illustrates an example of a preferred embodiment of the invention.

FIG. 10 illustrates an example of an alternative preferred embodiment of the invention.

### DETAILED DESCRIPTION OF THE PREFERRED EMBODIMENTS

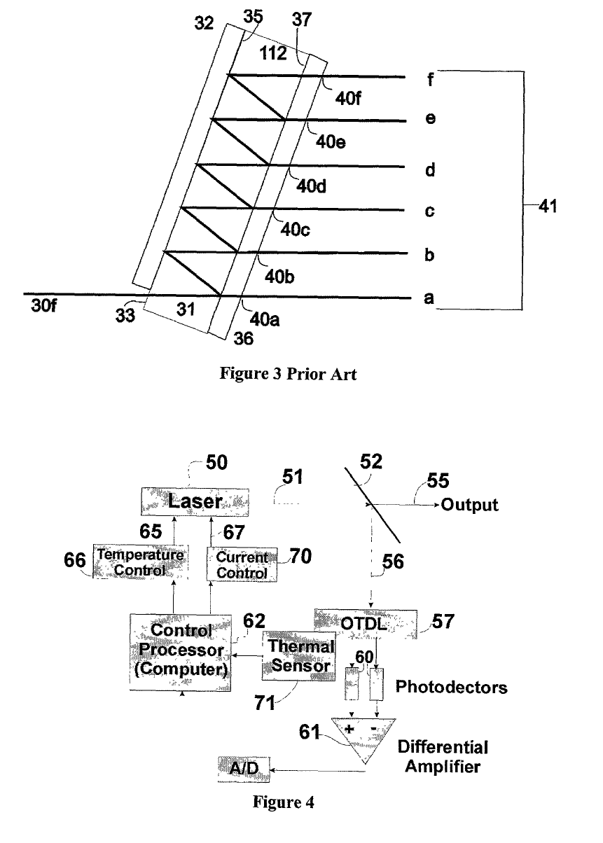

FIGS. 2 and 3 illustrate an optical tapped delay line that has particular utility when incorporated into a preferred embodiment of the present invention. It is the subject of co-pending U.S. patent application Ser. No. 09/687,029, filed Oct. 13, 2000, which is incorporated herein by reference. With reference to FIG. 2, six collimated input beams 30a-30f enter a transparent plate 31. The origin of the beams may be, for example, the collimated output of six optical fibers (not shown) where each fiber typically carries multiple wavelength channels. Referring to FIG. 3, the plate 31 has a first surface 32 that is provided with a coating 35 that is substantially 100% reflective. The plate 31 has a second surface 36 that is spaced from and opposed to the first surface 32. The second surface 36 is provided with a coating 37 that is partially reflective.

In the illustrated embodiment, transparent plate 31 separates the reflective surface coatings 35 and 37. In alternative embodiments (not illustrated), the reflective surfaces may be separated by other transparent materials, including air, other gas, or empty space. The transparent plate may also be referred to as an optical cavity.

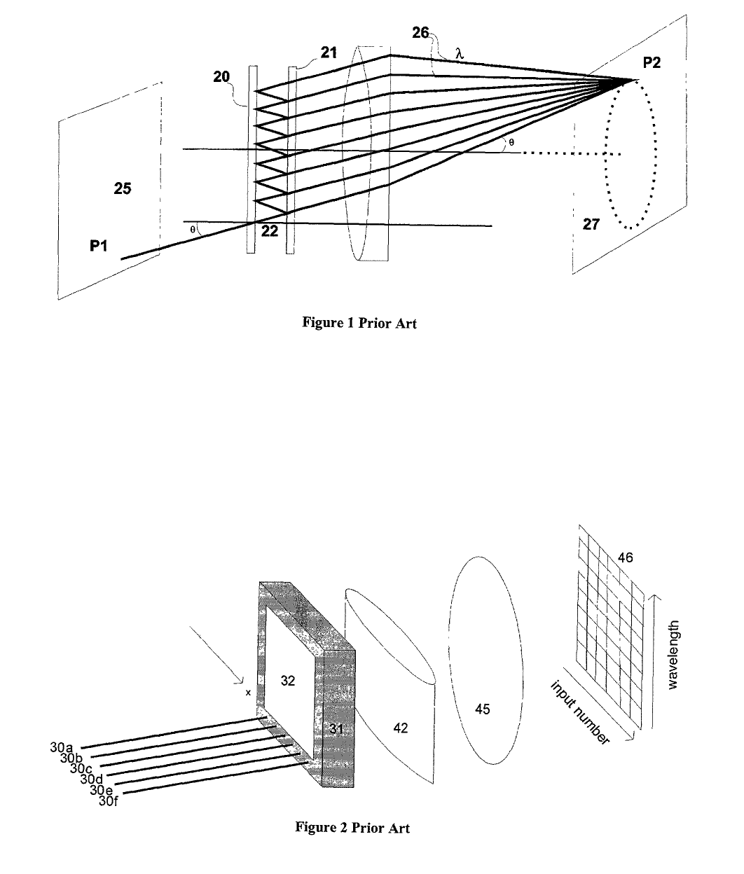

FIG. 3 illustrates an example of an operational side view of the device shown in FIG. 2. The single input beam 30f illustrated in FIG. 3 corresponds to the input beam 30f illustrated as one of the multiple input beams 30a-30f in FIG. 2. Due to the perspective of FIG. 3, the other input beams 30a-30e are not illustrated. However, it will be understood that the other multiple input beams 30a-30e reside behind the input beam 30f in the view shown in FIG. 3, and that the device is capable of processing and channelizing all of the multiple input beams simultaneously. Referring to FIG. 3, the input beam 30f enters the cavity 31 as a collimated beam of light through a hole 33, i.e., a section of plate 31 that is not covered by reflective coating 35. This feature in particular distinguishes the OTDL from other prior are devices, such as the Fabry-Perot etalon illustrated in FIG. 1, in which light enters directly through the partially reflective coating 20. While collimating the input beam 30f is necessary, focusing of the input beam is not required. After entering the cavity 31, a portion of the collimated input beam exits the cavity at a first location or “tap” 40a as collimated output beam 41a. Another portion of the collimated input beam is partially reflected by the coating 37 and then totally reflected by the coating 35. In other words, a portion of the beam “bounces” from the coating 37 to the coating 35 and then back. This reflected beam exits at a second location or tap 40b that is slightly displaced spatially from the first tap 40a. As a result of the bounce, the distance traveled by the output beam 41b is slightly greater than the distance traveled by output beam 41a. The width of the optical cavity 31 between reflective surfaces 32 and 36 thereby introduces a slight time delay between adjacent taps. The reflective process is continued, producing multiple additional collimated output beams 41a-f exiting the cavity 31 at multiple tap locations 40a-f. The result is a series of output beams that are distributed in the y direction with a progressive time delay from beam to beam.

The various beams remain substantially collimated throughout the reflective process. Divergence of the beams and interference among the beams is minimized. Numerous internal reflections within the cavity 31 may be achieved without substantial divergence or interference.

In the embodiment shown in FIG. 2, the various output beams are then directed to an anamorphic optical system 42, 45 that is spaced from the optical cavity 31. In the illustrated embodiment the anamorphic optical system comprises a cylinder lens 42 and a spherical lens 45. The anamorphic optical system performs the functions of: 1) Fourier transformation of the output of the cavity 31 in the vertical dimension y, and 2) imaging of the output of the cavity 31 in the horizontal dimension x onto an output surface 46. Although not illustrated in FIG. 2, it will be recognized that the optical system 42, 45 may have some form other than anamorphic as described above, depending on the particular application of the OTDL device. The functions performed may be, for example, Fourier transformation in both dimensions, partial or fractional Fourier transformation in one or both dimensions, imaging, or any combination of these functions.

The output surface 46 illustrated in FIG. 2 is two-dimensional, with the vertical dimension corresponding to the wavelength of the light in the input beam. There are a wide variety of devices that might be positioned at the output surface 46. For example, a detector array, a lenslet array, a light pipe array, a fiber optic bundle, an array of graded index (GRIN) lenses or any combination of the above may be positioned at the output surface 46.

FIG. 4 illustrates an example of a laser wavelength locker system in accordance with the teaching of the invention, in a preferred embodiment. A laser 50 provides a coherent beam 51 to a beam splitter 52. Beam splitter 52 is designed to permit the majority of energy to pass directly through to output 55, with a smaller quantity of the energy, perhaps 5%, being reflected as beam 56 to an OTDL 57 as illustrated in FIG. 2 and 3. The output of OTDL 57 illuminates a suitable optical detector array 60, such as a grid of photodetectors, which convert the received optical energy into electrical signals. The electrical signals are fed into a differential amplifier 61, which provides control signals to a processor 62, such as a computer. The output of laser 50 is determined and continuously adjusted according to temperature control signal 65 from temperature control 66 and signal 67 from current control 70. A thermal sensor 71 continuously monitors the temperature of OTDL 57 and provides the temperature information to processor 62.

During stable operation, laser 50 provides coherent light having a constant wavelength to output 55 and OTDL 57. OTDL similarly emits an unchanging light pattern onto the optical detector array 60. The constant signals from both differential amplifier 61 and thermal sensor 71 received by processor 62 invoke no changes by temperature control 66 or current control 70 to alter the output of laser 50.

Any change in the wavelength of laser 50, however, will alter the energy pattern incident on detector array 60, and thereby the electrical inputs to differential amplifier 61, due to the properties of the OTDL as explained above with respect to FIGS. 2 and 3. Processor 62 combines the new information from differential amplifier 61 and thermal sensor 71, and provides information to temperature control 66 and current control 70 as appropriate, to return the output of laser 50 to the correct wavelength.

In contrast to the prior art etalons such as that shown in FIG. 1 of the previously discussed Hall '700 patent, the OTDL 57 in FIG. 4 provides the ability to resolve wavelength channel spacings as narrow as 1 pm and less. It is the unique features of OTDL 57 that permit the device of FIG. 4 to achieve significantly higher wavelength resolution through its dramatically greater sensitivity, ambiguity, separation and stability. The OTDL 57 of FIG. 4 may be configured in a number of ways for specific applications.

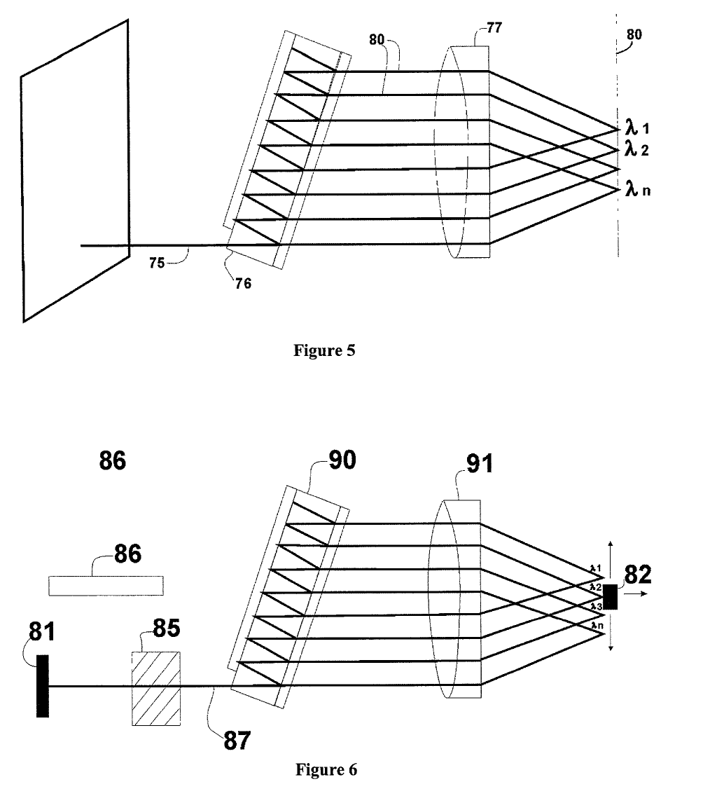

FIG. 5 illustrates an example of an OTDL configured for spatially resolving the optical wavelength spectrum of an incoming optical signal. An incoming multi-frequency light beam 75 is directed into OTDL 76. Lens 77 performs a Fourier transform on the multiple beamlets 80 emerging from OTDL 77, which spatially separates the beam into its component wavelengths λ₁, λ₂, . . . λₙ at output plane 80. In this configuration, the device functions as a spectrum analyzer.

While FIG. 4 illustrates an example of an embodiment of the invention with the OTDL residing in a feedback loop external to the laser cavity, FIG. 6 illustrates an example of the invention configured as a fixed or tunable wavelength stabilizer residing effectively within the laser cavity. Partially reflective mirrors 81 and 82 define a laser cavity. A suitable lasing medium 85 such as a semiconductor is pumped by a suitable energy source 86 to generate an optical output beam 87. Output beam 87 is processed by OTDL 90 and Fourier lens system 91 as previously described to illuminate mirror 82 at the focal plane of lens system 91. Because mirror 82 is partially reflective, a portion of the light energy incident on the mirror will be reflected back through Fourier lens 91 and OTDL 90, through lasing medium 85, and reflected by mirror 81. Because the OTDL spatially resolves different wavelengths of light, the vertical position of mirror 82 selects the wavelength that is allowed to resonate and lase within the cavity. As illustrated, the selected resonating wavelength is identified as λ_{2.} Other wavelengths such as λ₁ and λ₃ are not reflected and therefore cannot resonate and lase. In a fixed wavelength stabilizer, the position of mirror 82 will be fixed. A tunable device results if mirror 82 is permitted to move vertically to enable selection of any one of the wavelengths λ₁, λ₂, λ₃, . . . λₙ.

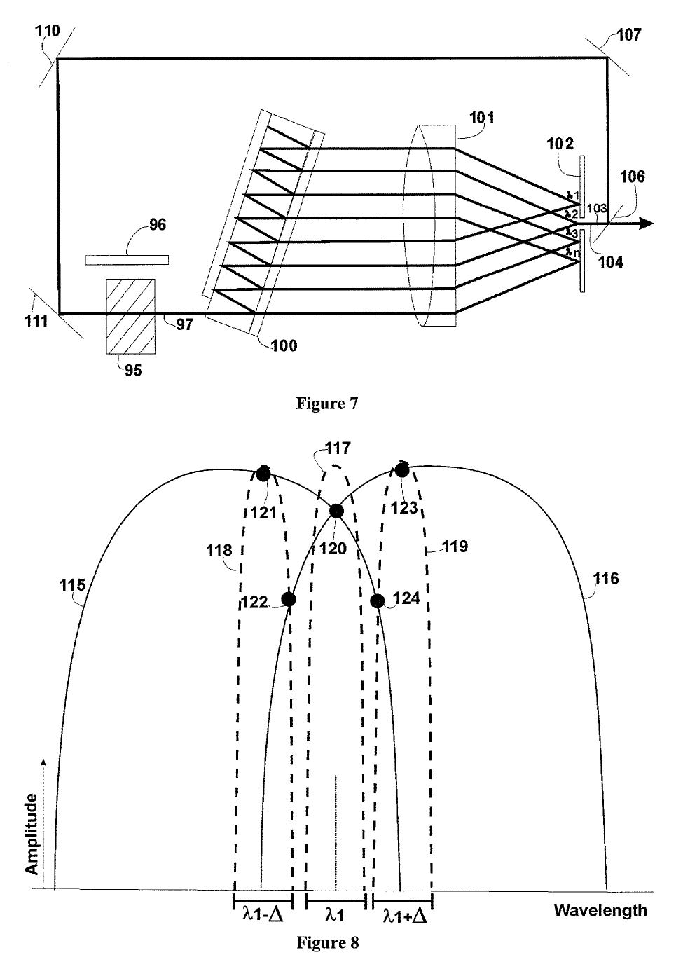

FIG. 7 illustrates an example of an alternative embodiment of the invention configured as a fixed or tunable wavelength stabilizer residing effectively within the laser cavity. A suitable lasing medium 95 such as a semiconductor is pumped by a flash tube or light emitting diode 96 to generate an optical output beam 97. Output beam 97 is processed by OTDL 100 and Fourier lens system 101 as previously described to focus a plurality of discrete wavelengths λ₁, λ₂, . . . , λₙ on an opaque stop 102 at the focal plane of lens 101. An aperture 103 in stop 102 is vertically positioned to permit a selected beam 104 having a selected wavelength, in this illustration λ₂, to pass through stop 102 to partially reflecting mirror 106. Mirrors 107, 110 and 111 reflect beam 104 back into lasing medium 95. Because the OTDL spatially resolves different wavelengths of light, the vertical position of stop 102 selects the wavelength that is allowed to resonate and lase within the cavity. Other wavelengths such as λ₁ and λ₃ are not passed back through the lasing medium and therefore cannot resonate and lase. In a fixed wavelength stabilizer, the position of stop 102 will be fixed. A tunable device results if stop 102 is permitted to move vertically to enable selection of any one of the wavelengths λ₁, λ₂, λ₃, . . . λₙ.

### OPERATION

The operation of the instant invention, in a preferred embodiment, can be best understood with reference to FIG. 8, which is a graph illustrating the amplitude response of two detector channels (115, 116) set to center a wavelength at λ₁. The response of one detector as a function of the laser wavelength is shown as curve 115. The response of the adjacent detector is shown as 116. When the laser is lasing at the desired wavelength, λ₁, the response of both detectors is equal 120. If the laser drifts down in wavelength then the response of one detector increases 121 and the other decreases 122. Conversely, if the laser drifts upwards in wavelength, the detectors respond in an opposite sense 123, 124. The control electronics can use this response difference, and its directional information, to control, “drive”, the laser back to its proper wavelength λ₁.

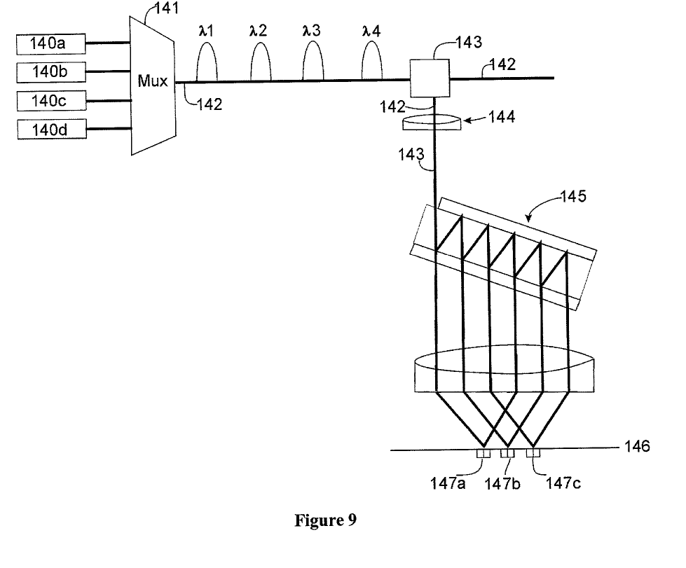

FIG. 9 illustrates an example of a preferred embodiment of the invention with one OTDL device simultaneously measuring wavelengths generated by four different lasers. Laser/modulators 140a-140d each provide a collimated output comprising a WDM information-carrying channel. A multiplexer 141 combines the four signals λ₁, λ₂, λ₃, and λ₄ into a single WDM optical beam carried on an optical fiber 142. A 95/5 beam splitter 143 divides the beam, with 95% of the energy passing on through the communication system and 5% directed through collimating lens 144. An OTDL 145 receives the collimated beam 143 and spatially separates the four channels as previously described. Detectors 147 at focal plane 146 measure variations in the channel wavelengths as previously described with respect to FIG. 8. Suitable detectors include a photodetector array for electrical processing. Alternatively, 147 could be pairs of micromirrors or lenslets for coupling to a fiber for sending the information to another optical subsystem.

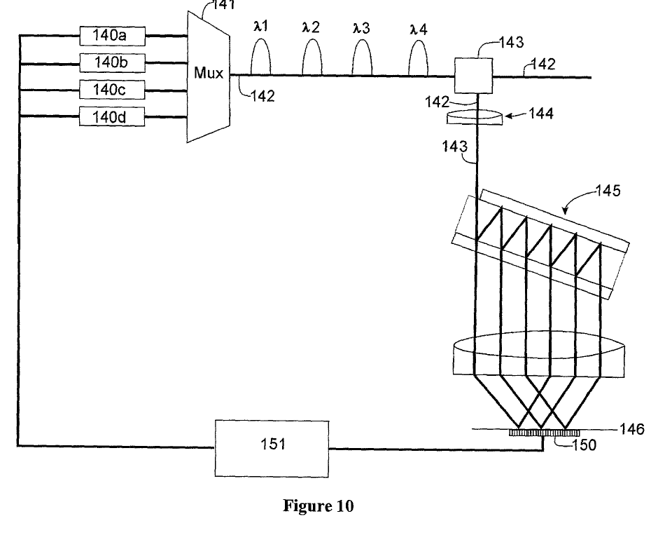

FIG. 10 is another preferred embodiment of this invention, illustrating a laser feedback system in which the detector 150 is an array of very finely spaced detectors. The precision measurements across multiple locations permitted by this device allows for precise measurement of laser drift. These measurements may be sent to a processor 151, which would provide feedback to the original lasers 140a- 140d in accordance with well-known procedures.

The invention is subject to numerous other arrangements that will be readily apparent to one skilled in the art. Accordingly, the preferred embodiments described and shown in the accompanying drawings are merely illustrative and are not to be interpreted as limiting the claims that follow.

What is claimed is:

1. An apparatus comprising:
a laser,
an optical tapped delay line having an input for receiving a collimated beam from the laser and an output to which is provided multiple time-delayed output beams, the collimated beam comprising a plurality of predetermined wavelengths, the multiple time-delayed output beams being mutually phase-shifted as a function of the wavelengths of the collimated beam and being spatially distributed, whereby the collimated beam is channelized into constituent predetermined wavelengths, and
means associated with the output for detecting variations in the constituent wavelengths over time.

2. The apparatus of claim 1 wherein the laser comprises a plurality of lasers.

3. The apparatus of claim 1 wherein the detecting means comprises at least one of a point detector, a fiber, a photo detector array, and a fiber array.

4. The apparatus of claim 1, comprising an optical system for operating on the multiple time-delayed output beams exiting the second surface to channelize at least one corresponding input beam into constituent frequencies.

5. The apparatus of claim 1, comprising means for controlling the laser in accordance with the detected variations to return the collimated beams to their predetermined wavelengths.

6. The apparatus of claim 5 wherein the controlling means comprises a programmable processor.

7. The apparatus of claim 5, comprising a resonant cavity in which:
a lasing medium is positioned between a first mirror and the optical tapped delay line such that the collimated beam from the laser passes through the lasing medium before entering the optical tapped delay line, and
a second mirror positioned to reflect a predetermined one of the channelized wavelengths back through the optical tapped delay line and the lasing medium to the first mirror,
whereby the cavity resonates at the predetermined one of the channelized wavelengths.

8. The apparatus of claim 5, comprising a resonant cavity in which:
a lasing medium is positioned between a mirror and the optical tapped delay line such that a beam incident on the mirror passes through the lasing medium before entering the optical tapped delay line,
an optical stop positioned such that a predetermined one of the channelized wavelengths passes through the stop,
means for reflecting the predetermined channelized wavelength back to the mirror,
whereby the cavity resonates at the predetermined one of the channelized wavelengths.

9. The apparatus of claim 8, comprising means for positioning the stop whereby the predetermined one of the channelized wavelengths may be selectively tuned.

10. An apparatus comprising:
a plurality of lasers, each having an output beam at a unique predetermined wavelength,
means for multiplexing the laser output beams into a collimated beam an optical tapped delay line having an input for receiving the collimated beam and an output to which is provided multiple time-delayed output beams, the multiple time-delayed output beams being mutually phase-shifted as a function of the wavelengths of the collimated beam and being spatially distributed, whereby the collimated beam is channelized into constituent predetermined wavelengths,
means connected to the output for detecting variations in the constituent wavelengths over time, and
means for controlling each laser in accordance with the detected variations to return each laser output beam to its predetermined wavelength.

11. The apparatus of claim 10 wherein the detecting means comprises a plurality of optical couplers positioned to receive the spatially distributed output beams, each coupler connected to an optical fiber.

12. The apparatus of claim 10 wherein the detecting means comprises a plurality of photodetectors positioned to receive the spatially distributed output beams, selected pairs of the photodetectors connected to a differential amplifier.

13. A method comprising:
providing an optical tapped delay line,
exposing the optical tapped delay line to a collimated beam from a laser, the collimated beam comprising a plurality of wavelengths,
producing multiple time-delayed output beams, the output beams being mutually phase-shifted as a function of the wavelengths of the collimated beam and being spatially distributed, thereby channelizing the collimated beam into constituent wavelengths, and
detecting variations over time in the constituent wavelengths.

14. The method of claim 13 comprising exposing the optical tapped delay line to a collimated beam from a plurality of lasers.

15. The method of claim 13 comprising detecting variations over time in the constituent wavelengths using at least one of a point detector, a fiber, a photo detector array, and a fiber array.

16. The method of claim 13 comprising optically operating on the multiple time-delayed output beams to channelize at least one corresponding input beam into constituent frequencies.

17. The method of claim 13 comprising controlling the laser in accordance with the detected variations to return the collimated beams to their predetermined wavelengths.

18. The method of claim 13, comprising:
positioning a lasing medium between a first mirror and the optical tapped delay line such that the collimated beam from the laser passes through the lasing medium before entering the optical tapped delay line, and
positioning a second mirror to reflect a predetermined one of the channelized wavelengths back through the optical tapped delay line and the lasing medium to the first mirror,
thereby establishing a resonant cavity which resonates at a predetermined one of the channelized wavelengths.

19. The method of claim 13, comprising:
positioning a lasing medium between a mirror and the optical tapped delay line such that a beam incident on the mirror passes through the lasing medium before entering the optical tapped delay line,
positioning an optical stop such that a predetermined one of the channelized wavelengths passes through the stop,
reflecting the predetermined channelized wavelength back to the mirror,
thereby establishing a resonant cavity which resonates at a predetermined one of the channelized wavelengths.

20. The method of claim 19, comprising positioning the stop whereby the predetermined one of the channelized wavelengths may be selectively tuned.

21. A method comprising:
providing a plurality of lasers, each having an output beam at a unique predetermined wavelength,
multiplexing the laser output beams into a collimated beam providing an optical tapped delay line having an input for receiving the collimated beam and an output to which is provided multiple time-delayed output beams, the multiple time-delayed output beams being mutually phase-shifted as a function of the wavelengths of the collimated beam and being spatially distributed, whereby the collimated beam is channelized into constituent predetermined wavelengths,
detecting variations in the constituent wavelengths over time, and controlling each laser in accordance with the detected variations to return each laser output beam to its predetermined wavelength.

22. The method of claim 21 comprising positioning a plurality of optical couplers to receive the spatially distributed output beams and connecting each of the plurality of optical couplers to an optical fiber.

23. The method of claim 21 comprising positioning a plurality of photodetectors to receive the spatially distributed output beams, and connecting selected pairs of the photodetectors to a differential amplifier.
